(19) United States
(12) Patent Application Publication
(10) Pub. No.: US 2026/0037350 A1
(43) Pub. Date: Feb. 5, 2026

(54) MAKING REMOTE PROCEDURE CALLS OVER QUIC PROTOCOL, AND APPLICATIONS THEREOF

(71) Applicant: Oxylabs, UAB, Vilnius (LT)

(72) Inventors: Gediminas Dagys, Neringa (LT); Vitalij Suckel, Vilnius (LT)

(73) Assignee: Oxylabs, UAB, Vilnius (LT)

(21) Appl. No.: 19/197,582

(22) Filed: May 2, 2025

Related U.S. Application Data
(60) Provisional application No. 63/677,298, filed on Jul. 30, 2024.

(51) Int. Cl. G06F 9/54; H04L 69/164

(52) U.S. Cl. CPC G06F 9/547; H04L 69/164

(57) ABSTRACT

A computer-implemented method is provided that enables remote control of a headless browser. A message from a client to open a connection to a headless browser running on a device remote from the client is received. A command to provision the browser is sent to the headless browser. The command may configure the browser to appear as if the browser is controlled by a human. A command for controlling the headless browser is received from the client. The command is sent to the headless browser for execution. A response to the command is received from the headless browser. Finally, the response is forwarded to the client.

### CROSS REFERENCE TO RELATED APPLICATIONS

This application claims benefit of and priority to U.S. Application No. 63/677,298, filed Jul. 30, 2024, which is incorporated by reference in its entirety.

### BACKGROUND

### Field

This field is generally related to improving web scraping technology.

### Related Art

Web scraping (also known as screen scraping, data mining, web harvesting) is the automated gathering of data from the Internet. It is the practice of gathering data from the Internet through any means other than a human using a web browser. Web scraping is usually accomplished by executing a program that queries a web server and requests data automatically, then parses the data to extract the requested information. Often, this is performed using a headless browser. A headless browser is a web browser without a graphical user interface. Headless browsers provide automated control of a web page in an environment similar to popular web browsers, but they are executed via a command-line interface or using network communication.

Web scraping is useful for a variety of applications. In a first example, web scraping may be used for search engine optimization. Search engine optimization (SEO) is the process of improving the quality and quantity of website traffic to a website or a web page from search engines. To raise the location of a website in search results, SEO may, for example, involve cross-linking between pages, adjusting the content of the website to include a particular keyword phrase, or updating the content of the website more frequently. An automated SEO process may need to scrape search results from a search engine to determine how a website is ranked among search results.

In a second example, web scraping may be used to identify a possible copyright. In that example, the scraped web content may be compared to copyrighted material to automatically flag whether the web content may be infringing a copyright holder's rights. In one operation to detect copyright claims, a request may be made of a search engine, which has already gathered a great deal of content on the Internet. The scraped search results may then be compared to a copyrighted work.

In a third example, web scraping may be useful to check placement of paid advertisements on a webpage. For example, many search engines sell keywords, and when a search request includes the sold keyword, they place paid advertisements above unpaid search results on the returned page. Search engines may sell the same keyword to various companies, charging more for preferred placement. In addition, search engines may segment as sales by geographic area. Automated web scraping may be used to determine ad placement for a particular keyword or in a particular geographic area.

In a fourth example, web scraping may be useful to check prices or products listed on e-commerce websites. For example, a company may want to monitor a competitor's prices to guarantee that their prices remain competitive.

E-commerce and search engine sites may prefer not to service web scraping requests or may try to limit web scraping requests. To that end, these sites may try to determine which of the requests they receive are automated and which requests are in response to a human web browsing request. When a web server identifies a request that the server believes to be automated, the server may block that request.

At least in part to try to avoid a request from being blocked, the web request may be sent through a proxy server. The proxy server then makes the request on the web scraper's behalf, collects the response from the web server, and forwards the web page data so that the scraper can parse and interpret the page. When the proxy server forwards the requests, it generally does not alter the underlying content, but merely forwards it back to the web scraper. A proxy server changes the request's source IP address, so the web server is not provided with the geographical location of the scraper. Using the proxy server in this way can make the request appear more organic and thus ensure that the results from web scraping represent what would actually be presented were a human to make the request from that geographical location.

Sending all the requests by proxy may generate a large amount of transactions going back and forth. For example, in a situation where an HTML page has a large number of elements in the page, not only is the request for the HTML page sent through the proxy, the request for each individual element may also be sent to the proxy. This may generate a large amount of traffic going back and forth. Systems and methods are needed for more efficient web scraping, for evaluation of web content generally, and for other data transmission and reception through a surrogate.

A remote procedure call is when a computer program causes a procedure (subroutine) to execute in a different address space (commonly on another computer on a shared computer network), which is written as if it were a normal (local) procedure call, without the programmer explicitly writing the details for the remote interaction. Typically, RPC (typically an application layer protocol) uses TCP or UDP for transport layer communications. However, TCP/UDP in itself is not secure. When SSL transactions are added on top of TCP/UDP to ensure their security, the number of transactions needed to set up the connection increases. Systems and methods are needed for more efficient intra-process communication.

### BRIEF SUMMARY

In a first embodiment, a computer-implemented method is provided that enables remote control of a headless browser. A message from a client to open a connection to a headless browser running on a device remote from the client is received. A command to provision the browser is sent to the headless browser. The command may configure the browser to appear as if the browser is controlled by a human. A command for controlling the headless browser is received from the client. The command is sent to the headless browser for execution. A response to the command is received from the headless browser. Finally, the response is forwarded to the client.

In a second embodiment, a computer-implemented method is provided that warms up a headless browsers in advance of a client requesting them. In the method, a plurality of headless browsers, each having an individual configuration, is initialized. After the plurality of headless browsers is initialized, a request to control a headless browser is received from the client. The request specifies a desired configuration for a headless browser session. Based on the desired configuration, one of the plurality of headless browsers is selected. A command to control a headless browser is received from the client. The received command is forwarded to the selected headless browser.

In a third embodiment, a computer-implemented method is provided for executing a function on a remote device. In the method, a Quick UDP Internet Connections (QUIC) handshake is executed to create a QUIC session between a first and second peer device. A QUIC stream is opened on the QUIC session between the first and second peer device. It is also noted that either of the peer devices can open a new stream, and initiate a request over it. A request frame is generated on the first peer, which initiated (opened) the new stream. The request frame includes (i) a function name identifying a method on the second peer (which accepted the stream) to call using Remote Procedure Call (RPC) and (ii) a first payload including arguments for the function. The request frame is sent over the QUIC stream. Finally, a response frame is received on the first peer from the second peer. The response frame includes an indication of that the method was successfully executed by the server (e.g., the second peer) and a second payload with data from the Remote Procedure Call (RPC).

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF THE DRAWINGS

The accompanying drawings are incorporated herein and form a part of the specification.

FIG. 1 is a diagram showing a conventional way a web request is sent through a proxy.

FIG. 2 is a system diagram showing a system for scraping using a remote headless browser.

FIG. 3 is a flowchart showing a method for scraping using a headless browser through an infrastructure, according to an embodiment.

FIG. 4 is a flowchart expanding on the method of FIG. 3 and showing how an infrastructure server can intercept and expand on commands sent to the headless browser.

FIG. 5 is a flowchart showing a method for warming up browser, according to an embodiment.

FIG. 6 is a flowchart illustrating a more detailed method for warming up browser according to an embodiment.

FIGS. 7A and 7B is a diagram illustrating packets to allow RPC to transact over a QUIC protocol, according to an embodiment.

FIGS. 8 and 9 illustrate transacting packets over RPC according to an embodiment.

FIG. 10 is a flowchart showing a method for utilizing an internal proxy, according to an embodiment.

FIG. 11 is a system diagram illustrating an example computing device, according to an embodiment.

In the drawings, like reference numbers generally indicate identical or similar elements. Additionally, generally, the left-most digit(s) of a reference number identifies the drawing in which the reference number first appears.

### DETAILED DESCRIPTION

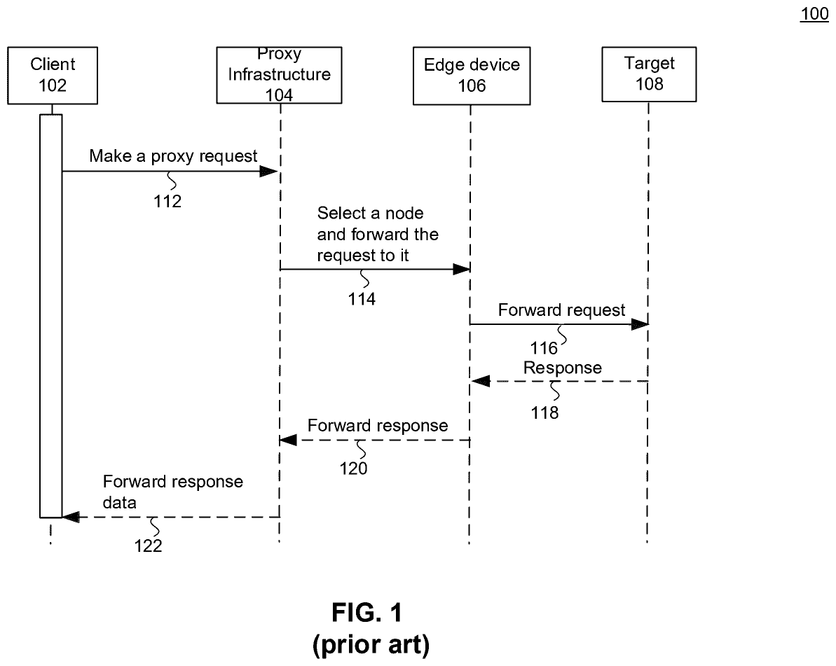

FIG. 1 is a diagram showing a conventional way a web request is sent through a proxy. As shown, system 100 includes client 102, proxy infrastructure 104, edge device 106, and target 108.

Client 102 may be a computing device operated by a user wishing to access target 108 indirectly via proxy infrastructure 104. Client 102 is configured to make a proxy request 112 to proxy infrastructure 104 to access target 108 on client 102's behalf. Client 102 may have software (not shown) that can generate a hypertext transfer protocol (HTTP) request, such as from a web browser. The web browser may be a headless web browser, and client 102 may generate commands to send to the headless browser using a command language, such as Chrome DevTools Protocol. To generate the commands, client 102 may use a library such as Playwright, Puppeteer, etc. or a framework such as Selenium. Client 102 may send the HTTP request generated by the headless browser as a proxy request 112 using a proxy protocol, such as HTTP Proxy Protocol or SOCKS5.

Proxy infrastructure 104 is a collection of computing resources and software configured to receive proxy requests like proxy request 112 from clients and forward them to an appropriate exit proxy for accessing the target. Upon receiving proxy request 112 from client 102, proxy infrastructure 104 selects a proxy peer and forwards the request to it at 114.

The selected node acts as an edge device 106. Edge device 106 is a computing device that actually makes the request to target 108 on behalf of client 102. It receives the forwarded request from proxy infrastructure 104 at 116 and sends the request to target 108.

Target 108 is the computing device, resource, or service that client 102 ultimately wishes to access or communicate with, such as a web server. Target 108 receives the forwarded request from edge device 106, processes it, and sends a response 118 back to edge device 106.

Edge device 106 receives response 118 from target 108 and forwards the response data at 120 back to proxy infrastructure 104. Proxy infrastructure 104 then forwards the response data from edge device 106 at 122 to client 102. This allows client 102 to receive the response from target 108 without direct communication between client 102 and target 108.

This allows client 102 to indirectly access target 108 without revealing client 102's IP address to target 108. The proxy infrastructure 104 and edge devices 106 act as intermediaries to disguise the origin of the requests. Target 108 only sees the request as coming from edge device 106 and has no visibility that it originated from client 102.

Making a proxy request in this way requires a client to know how to run a browser on client 102 properly. This may require knowledge of techniques needed to properly mask the fact that the request is automated. In addition, making a proxy request in this way may require costly infrastructure. More requests may need to be generated, as every transaction from target 108 may need to be sent back to client 102. Client 102 may need to generate subsequent requests based on this. Each request-response cycle may need to traverse the entire infrastructure.

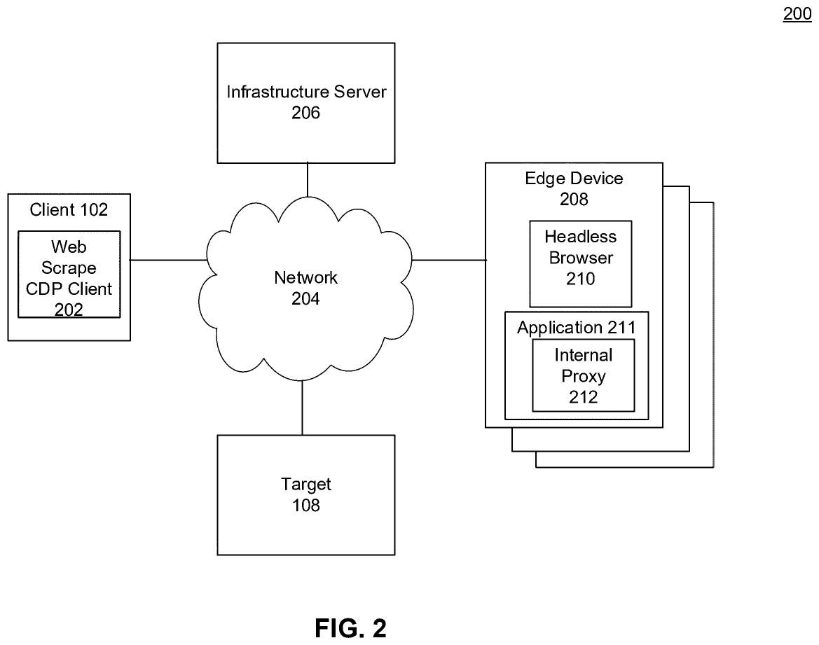

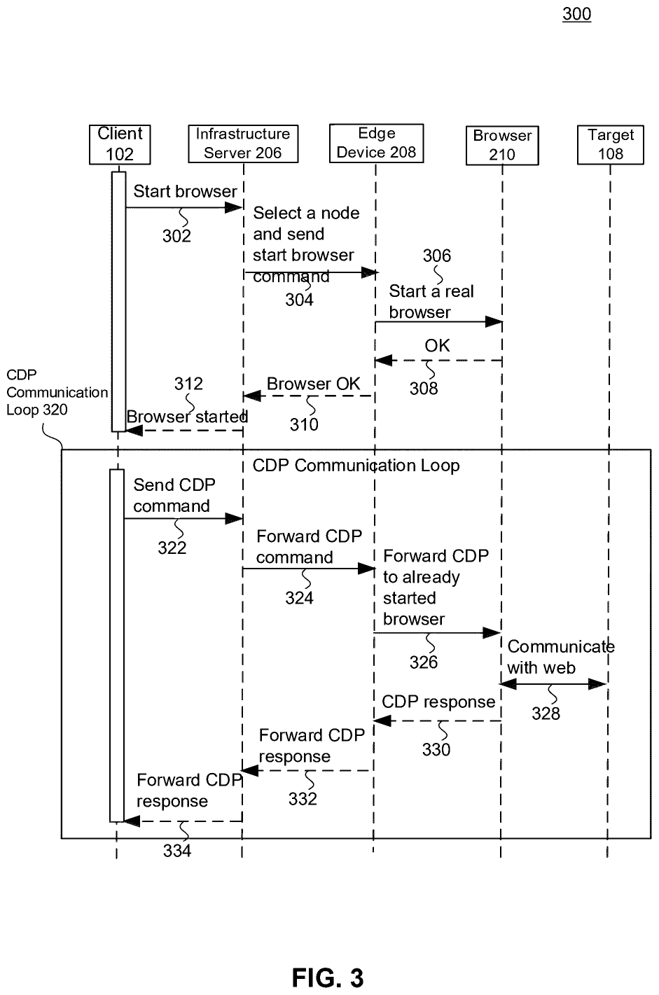

At least in part to deal with these issues, embodiments run headless browsers on real edge devices browsers in “invisible” (headless) mode. This may have an advantage of using real user fingerprints, which may make for easier scraping and less blocking of requests for being automatically generated. Resource usage and distribution among network participants may be more efficient. Commands may be forward from a client to edge device browser and back. This is illustrated, for example, in FIGS. 2 and 3.

FIG. 2 is a system diagram showing a system 200 for scraping using a remote headless browser. System 200 includes some components in common with system 100 of FIG. 1, as well as some differences. The common components include client 102 and target 108. However, instead of a proxy infrastructure and separate exit proxy, system 200 utilizes an infrastructure server 206 that incorporates an edge device 208 running a headless browser 210. Additionally, edge device 208 may include application 211 and internal proxy 212.

Client 102 in system 200 incorporates a web scrape CDP (Chrome Devtools Protocol) client 202. The web scrape CDP client 202 is a software component that enables client 102 to remotely initiate and control an instance of headless browser 210 running on edge device 208. Web scrape CDP client 202 may expose an API, user interface, command line interface, or other means for a user of client 102 to configure and initiate web scraping jobs to be performed by headless browser 210. Web scrape CDP client 202 may include a library such as Playwright, Puppeteer, etc., or a framework such as Selenium. A CDP protocol may be used for communication between the client and browser, allowing for various actions such as opening pages, clicking links, and evaluating JavaScript on the page. While this description refers to CDP for illustrative purposes, a skilled artisan would recognize that other browser automation protocols, such as a Webdriver protocol or Webdriver Bidi protocol could also be used.

Infrastructure server 206 is connected to client 102 via network 204. Network 204 may be the public internet, a private LAN or WAN, or any other type of network sufficient for exchanging commands and data between client 102 and infrastructure server 206.

Infrastructure server 206 is a collection of computing resources and software configured to receive requests from client 202 and coordinate their execution by one of a plurality of edge devices 208. For example, infrastructure server 206 can select an appropriate one of the plurality of edge devices 208. Infrastructure server 206 can select the edge device 208 based on filtering criteria specified in a request from client 102. For example, infrastructure server 206 may select an edge device 208 located at a particular geographic location or with certain properties, like a certain type of web browser. For instance, client 102 may provide the country code corresponding to a particular geographic location where a selected edge device 106 is located. Infrastructure server 206 may also select an edge device 208 based on availability and to balance load, both for performance and to avoid an edge device 208 from being blocked. In some embodiments, infrastructure server 206 may select an edge device 208 with application 211 that infrastructure server 206 has a connection to. For example, infrastructure server 206 may establish a connection with application 211 at edge device 208, and therefore select edge device 208 to handle the request from client 102.

Each edge device 208 includes and is capable of executing a headless browser 210. Headless browser 210 is a web browser that can be used to retrieve and render web pages, but does not have a visible user interface. This makes headless browser 210 well-suited for automated tasks like web scraping. Examples of headless browsers include headless Chromium-based browsers (e.g. Google Chrome, Microsoft Edge, Vivaldi, etc.), or others that fully or partially support CDP protocol (e.g. Firefox), or browsers that are supported by Webdriver and/or Webdriver Bidi. These may be conventional browsers that are able to run in a headless mode. Each edge device 208 has its own IP address. Some may have residential IP addresses, while others may have data center IP addresses. But to target 108, edge device 208 appears to have the IP address that originates the web request. In some embodiments, edge device 208 may utilize internal proxy 212 to communicate with target 108 or an external proxy server.

In some embodiments, edge device 208 may leverage application 211 to execute headless browser 210. For example, application 211 may launch headless browser 210 on edge device 208. Application 211 may be a software program, such as a software development kit (SDK) installed on edge device 208. Edge device 208 may download application 211 from an entity on network 204 such as an application store. Application 211 may allow edge device 208 to communicate with infrastructure 206. For example, communications between edge device 208 and infrastructure server 206 may pass through application 211.

As will be described in greater detail below in FIG. 3, infrastructure server 206 also forwards commands from client 102 to the selected edge device 208. For example, once headless browser 210 is running, web scrape CDP client 202 may send one or more commands to instruct headless browser 210 to navigate to target 108 and retrieve content. Headless browser 210 sends retrieved content back to infrastructure server 206, which forwards it via network 204 to web scrape CDP client 202 on client 102.

In some embodiments, edge device 208 may launch internal proxy 212. Edge device 208 may leverage application 211 to launch internal proxy 212. Edge device 208 may launch internal proxy 212 when edge device 208 receives a command from infrastructure server 206. In some embodiments, application 211 may receive the command from infrastructure server 206 and launch internal proxy 212. Internal proxy 212 may be configured to pass messages between headless browser 210 and target 108, as well as headless browser 210 and other external proxy devices.

Noted above, edge device 208, or application 211, may launch internal proxy 212 when edge device 208 receives a command from infrastructure server 206. Once launched, internal proxy 212 may: (1) identify an unused port from an internal port list; (2) begin listening for new http proxy connections; and (3) provide the unused port to edge device 208. As noted above, edge device 208 may launch headless browser 210 for web scraping jobs. Edge device 208 may include the port of internal proxy 212 when launching headless browser 210. Edge device 208 may also include the IP address of internal proxy 212 when launching headless browser 210. The IP address of internal proxy 212 may be the local host IP address (e.g., 127.0.0.1). As a result, headless browser 210 may be configured to communicate with internal proxy 212 using the IP address (e.g., local host) and the port identified by internal proxy 212.

Once internal proxy 212 is launched, it may listen for a proxy connection. The proxy connection may be an HTTP CONNECT message. The proxy connection may originate from headless browser 210. Internal proxy 212 may be configured parse the proxy connection message. For example, internal proxy 212 may parse a header within the HTTP CONNECT message. In some embodiments, the HTTP CONNECT message may include an identifier of target 108. As a result, internal proxy 212 may connect to target 108. In some embodiments, the HTTP CONNECT message may include the identifier of an external proxy server to connect to. As a result, internal proxy 212 may connect to the external proxy server.

Beyond just forwarding the commands to client 102, infrastructure server 206 may filter and enrich commands, modifying them before they are forwarded on to edge device 208. When a client wants to initiate a web scraping job, the web scrape CDP client 202 on client 102 sends commands via network 204 to infrastructure server 206 to instantiate and configure headless browser 210. Infrastructure server 206 may enrich the command such as by setting various parameters of the browser environment to mimic human usage.

Using system 200, client 102 can efficiently automate retrieval of content from target 108. Headless browser 210 executing on remote edge device 208 simulates a human user accessing target 108, which may help avoid restrictions on automated access. Infrastructure server 206 and edge device 208 act as intermediaries, separating client 102 from direct interaction with target 108. By executing the headless browser 210 on the device that originates the request, human behavior imitating fingerprinting may be simpler. It may be more difficult for a target to determine that the request is automated as opposed to being generated by a real human browsing. As an additional advantage, running headless browsers 210 on various edge devices 208 may spread the processing load instead of requiring all headless browser request generation to be done at a central infrastructure server or at a central client device. Spreading processing load over more network participants may be advantageous to utilize computing resources more efficiently. As a still further advantage, using a headless browser helps to save some traffic in communication between client, server infrastructure and the edge device. Because the bigger part of traffic will be done between the edge device and the target, if the client requests only some exact parts of result content (instead of full HTML), it might help to reduce traffic in “client <-> edge device” chain drastically.

As noted above, edge device 208 may leverage application 211 to launch headless browser 210 and internal proxy 212 to pass messages between headless browser 210 and target 108, or other external proxy devices. In some aspects, internal proxy 212 may calculate and transmit metrics of the data passed between headless browser 210 and target 108. For example, internal proxy 212 may calculate: (1) a total number of messages sent and received by headless browser 210; (2) an amount of data sent and received by headless browser 210; and (3) an identifier of target 108 (e.g., an IP address).

In some embodiments, internal proxy 212 may be utilized to establish an authenticated communication session. Internal proxy 212 may establish an authenticated communication session with devices on network 204, such as an external proxy server. Internal proxy 212 may be configured to automatically establish an authenticated communication session with an external proxy server (e.g., by default). In some embodiments, internal proxy 212 may establish an authentication session based on a parameter provided edge device 208 or headless browser 210.

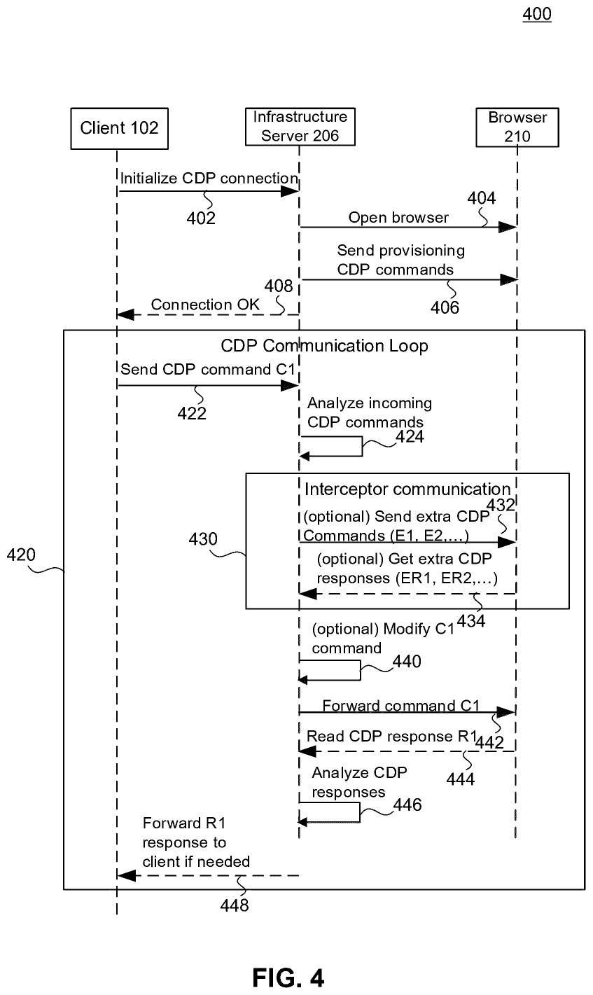

In some embodiments, internal proxy 212 may shutdown after content from target 108 is retrieved. For example, internal proxy 212 may shutdown in response to receiving a command from edge device 208, application 211, or headless browser 210. Prior to shutdown, internal proxy 212 may free the port it selected and utilized for proxying messages between headless browser 210 and target 108. More detail on communication flow is provided with respect to FIG. 3, and more detail on analysis and enrichment of browser commands is provided with respect to FIG. 4.

FIG. 3 is a more detailed diagram illustrating the components and communication flow in method 300 for controlling a remote headless browser according to an embodiment of the invention. Method 300 describes the interaction between client 102, infrastructure server 206, edge device 208, browser 210, and target 108.

Method 300 begins at 302 with client 102 sending a start browser command to infrastructure server 206. This command instructs infrastructure server 206 to initiate an instance of headless browser 210 on edge device 208. This command may specify arguments to use to start the browser. For example, the command may include information such as the language or screen parameters to use when starting the headless browser. This may be done using a remote CDP mode. In this way, starting the browser at 302 may involve making a request to a URL defining a remote CDP port. Arguments for the browser may be sent via parameters sent to the URL. The request may also include filtering criteria for selection of the edge device. From the client's perspective, infrastructure server 206 may appear to be running a CDP server that executes a headless browser on infrastructure server 206 itself.

Upon receiving start browser command 302, infrastructure server 206 selects an available edge device (i.e. edge device 208) at 304 and forwards the start browser command to the selected edge device 208. Infrastructure server 206 may select edge device 208 based on a country code or other geographic identifier provided by client 102. For example, client 102 may be located in a first geographic region, where content at target 108 is unavailable. Client 102 may include a geographic identifier, such as a country code where the content at target 108 is available. Thus, infrastructure server 206 may select edge device 208 in a second geographic region in order to retrieve the content and provide it to client 102 in the first geographic region. In some embodiments, infrastructure server 206 may select edge device 208 based on an active communication session with application 211 at edge device 208. As will be discussed with respect to FIG. 3, in some embodiments, additional provisioning commands may be sent to configure the browser.

At 306, edge device 208 receives the start browser command from infrastructure server 206 and launches an actual instance of headless browser 210. Noted above, the start browser command may be received by application 211, and application 211 may launch the instance of headless browser 210. This may involve first checking and seeing what browsers are available. For example, edge device 208 may check various paths on the device to determine what browsers are installed on the device. In some embodiments, application 211 may check the paths on edge device 208. If the browser is found, the browser may be started. This initialization may involve loading browser code into memory, setting initial configuration parameters, and readying the browser to receive further commands.

In some embodiments, edge device 208 may also launch an instance of internal proxy 212. In some embodiments, application 211 may launch the instance of internal proxy 212. Edge device 208 may launch internal proxy 212 prior to launching headless browser 210. Edge device 208 or application 211 may launch internal proxy 212, and wait to receive a port from internal proxy 212. The port may be the port that internal proxy 212 is listening for connections on. Edge device 208 may provide the port of internal proxy 212 and an IP address of internal proxy 212 to headless browser 210. As a result, headless browser 210 may connect to internal proxy 212.

Once browser 210 is started successfully, edge device 208 returns a browser OK message at 308 to infrastructure server 206 to signal that the browser is ready at 310. In some embodiments, application 211 may send the browser OK message to infrastructure server 206. Infrastructure server 206 propagates this browser OK message back to client 102 at 312.

Once client 102 receives the browser start message at 312 indicating that browser 210 is ready to accept commands, a CDP (Chrome Devtools Protocol) communication loop 320 is initiated between client 102 and browser 210 via infrastructure server 206. The CDP communication loop 320 begins with client 102 sending a CDP command at 322 to infrastructure server 206. As mentioned above, CDP is a protocol used to control and exchange messages with instances of the Chrome browser or other compatible browsers. CDP commands can be used for example to navigate to pages, retrieve content, and simulate user input.

Again, from the perspective of client 102, it may appear as if the command sent at 322 controls a headless browser running directly from infrastructure server 206. However, when infrastructure server 206 receives the CDP command from client 102 and forwards it at 324 to edge device 208, all communication between client 102 and browser 210 is mediated through infrastructure server 206. This allows infrastructure server 206 to monitor, log, and optionally modify the commands and responses. Edge device 208 then forwards the CDP command to the already started browser 210 at 326.

Browser 210 executes the received CDP command, which may involve communicating with target 108 at 328 to retrieve web page content. In some embodiments, browser 210 may communicate with internal proxy 212, and internal proxy 212 may communicate with target 108 to retrieve the web page content. Once the CDP command is processed, browser 210 sends a CDP response message at 330 to edge device 208. Edge device 208 receives the CDP response from browser 210 and forwards this response at 332 to infrastructure server 206. Finally, infrastructure server 206 forwards the CDP response back to client 102 at 334. The CDP protocol allows client 102 to have fine-grained, interactive control over browser 210.

This CDP communication loop 320 can continue with client 102 sending further CDP commands to browser 210 and receiving CDP responses in return. This allows client 102 to have direct, real-time control over the actions of remote browser 210 and receive the results of those actions. In one simple example, a CDP communication loop 320 may be for each CDP command. A first CDP command may be to open a page from a target site, a second CDP command may be to select a link on a page, a third CDP command may be to wait until the page is fully loaded, and a fourth CDP command may be to get the HTML content on the page. Each of these commands may involve a CDP communication loop 320 between client 102 and browser 210 (also accessing target 108, if required by the command).

Although only a single client 102, edge device 208, and browser 210 are shown, in practice infrastructure server 206 would likely mediate connections between many clients and many exit proxy/browser pairs. This allows load to be balanced across exit proxies and enables high scalability. Also, infrastructure server 206 may include many different devices hosting various micro-services.

In summary, system 200 provides an efficient means for client 102 to automate retrieval of web content from target 108 using a remotely controlled headless browser 210. The communication flow in method 300 enables client 102 to start and control a remote headless browser 210 through a series of CDP commands mediated by infrastructure server 206. Furthermore, by utilizing internal proxy 212, the amount of data passed between browser 210 and target 108 may be tracked. Internal proxy 212 may also establish an authenticated communication session with entities on network 204 such as external proxy servers, providing increased security to entities and communications on network 204. The architecture allows flexibility, configurability, and avoids the inefficiencies of multiple hops through separate proxy servers.

FIG. 4 is a flowchart illustrating the steps of a method 400 for remotely controlling a headless browser according to an embodiment of the invention. Method 400 may be performed by a system such as system 200 of FIG. 2, including a client 102, an infrastructure server 206, and a browser 210.

At step 402, the client initializes a CDP (Chrome Devtools Protocol) connection with the infrastructure server. This step establishes the communication channel that will be used to send commands and receive responses. As described above at step 302 in FIG. 3.

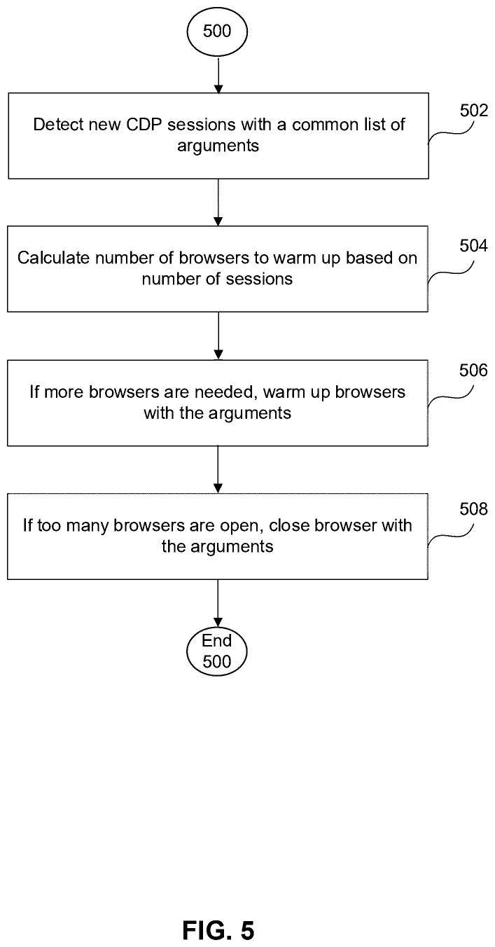

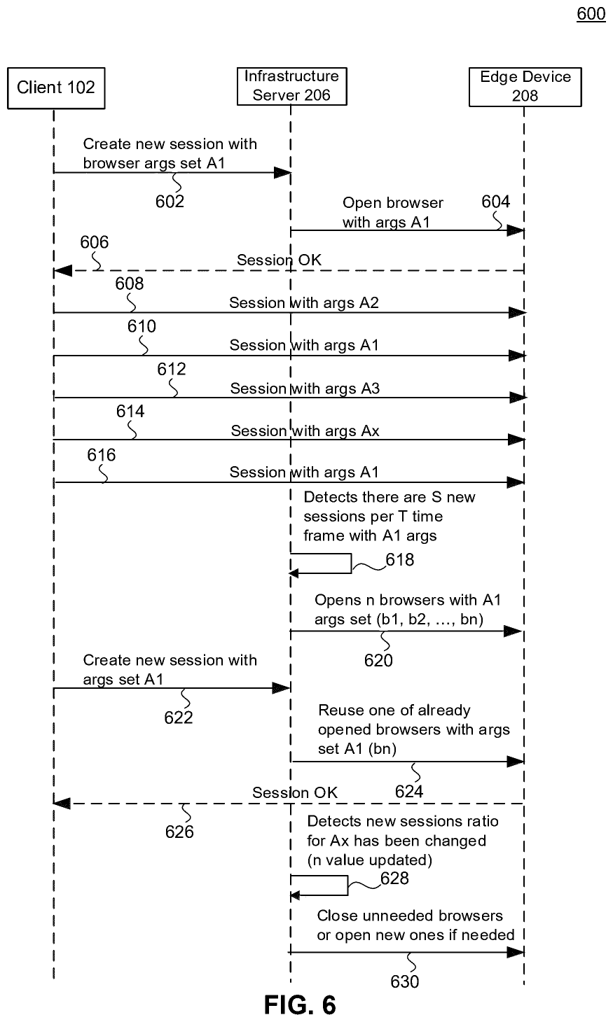

Once the CDP connection is established, at step 404 the infrastructure server 206 signals edge device 208 to open a browser. This may involve selecting an available instance of the browser with arguments as described below with respect to FIGS. 5 and 6 and readying it to receive commands. If no instance is available, a new one may be launched.

At step 406, infrastructure server 206 may send provisioning commands as described above. It also can provision and fine-tune the browser profile (this includes both cookies, browsing history, etc.), remove unnecessary browser-automation functionality and variables, setup browser notification settings and behavior, or setup authorization headers for using on different websites or using proxy servers with required authentication in a browser environment (this is the case when proxy-server browser arguments are passed, and later Proxy-Authorization header added). It is also possible to preload global variables with some desired state or to warmup the browser cache for specific use-cases.

The method then enters the main CDP communication loop 420. At step 422, the client sends a CDP command to the infrastructure server. The CDP command may be any command supported by the CDP protocol, such as navigating to a URL, clicking a button, or extracting page content.

Upon receiving the CDP command, at step 424 infrastructure server 206 analyzes the incoming CDP command. This analysis may involve parsing the command, validating its format and parameters, evaluating whether it may cause an edge device to be blocked for being automatically generated and possibly logging it for auditing or debugging purposes. This sort of analysis may not be possible with the method described with respect to FIG. 1, because after security information is exchanged between client 102 and target 108, all further communications between client 102 and target 108 are encrypted. Thus, any intermediate proxy infrastructure or server proxies merely forward on the encrypted content and may not be able to inspect its content. As an advantage of the method described the suspect to FIGS. 3 and 4, requests coming from client 102 can be analyzed, evaluated, and enriched.

For example, some webpages may have particular steps that need to be taken to close some un-wanted popups on the website. For example, it can be detected that the website is showing some unneeded popups before giving access to the content, so the popups can be automatically detected and closed. Similarly, there may need to be certain environment variables or history information set. Infrastructure server 206 can evaluate the CDP command and evaluate whether it seeks to access a website. If it does seek to assess a website, infrastructure server 206 can look up any measures to access the website from a database or table at step 424.

Based on the analysis, at optional step 426 the infrastructure server may modify the CDP command before forwarding it to the browser. Modifications may include adding, removing or changing parameters to enforce security policies, injecting custom JavaScript, or optimizing performance. The modification may further include adding additional commands to obscure the fact that the request was automatically generated, tracking the communication flow, and avoiding overloading any single browser or edge device. For example, the additional command may include a command to hide the fact that the browser is automated (perhaps executing the commands that had been looked up at step 424), or to report back an amount of data received.

At 430, infrastructure server 206 communicates with browser 210 to provide any extra commands (E1, E2, . . . ) needed to provide these additional services. For example, infrastructure server 206 may limit the number of tabs open on any browser to avoid overloading the browser. Client 102 may request that a tab be opened when browser 210 already has its maximum number of tabs running. In another example, it may be advantageous for infrastructure server 206 to track the amount of data received at or transmitted from browser 210. This data may be used, for example, to help with billing the client or otherwise counting for overall usage. Commands may be sent to browser 210 at 432 to request that browser 210 report back such statistical data. In either case, any responses to the CDP commands (ER1, ER2, . . . ) are returned to infrastructure server 206 from browser 210 at step 434. The CDP response includes any data or content generated as a result of executing the command.

As mentioned above, based on the analysis at step 424, infrastructure server 206 may determine that the command CI may need to be modified. If a modification is needed, the modification occurs at step 440.

At step 442, the infrastructure server forwards the CDP command, with any modifications, to the browser for execution. Browser 210 receives the command and performs the requested action. There may be communication between browser 210 and the target website (not shown). This communication may include sending HTTP requests, receiving HTML, CSS and JavaScript content, and executing dynamic functionality. Browser 210 sends a response RI to the CDP command to infrastructure server 206 at step 444.

At step 446, infrastructure server 206 analyzes the CDP response. In this way, based on the analysis, infrastructure server 206 determines whether additional response information needs to be forwarded to client 102. For example, if the response RI only includes information on the amount of data transacted, infrastructure 206 may choose not to forward that information onto client 102. However, if infrastructure server 206 determines at 446 that response RI is responsive to a client request, infrastructure server 206 forwards response RI to client 102 at step 448.

The CDP communication loop 420 repeats and continues until client 102 has retrieved all the desired data, allowing complex scraping tasks to be performed.

In this way, infrastructure server 206 acts as an intermediary between the client and browser, analyzing and potentially modifying the commands and responses. Method 400 provides a flexible and efficient means for a client to control a remote headless browser and extract desired web data. The CDP protocol and infrastructure server enables a wide range of potential use cases while preserving the performance and scalability advantages of the headless architecture.

As described above, before browser 210 can scrape data, browser 210 needs to be initialized using a set of arguments defined by client 102. The set of arguments may define, for example, the browser's screen or window size, whether the scroll bar on the browser should be visible, setting color profile of the browser, the browser's language, and the browser's extensions. Starting headless web browsers on an edge device takes time. This can cause delay in responding to CDP commands.

At least in part to deal with this delay, according to an embodiment, infrastructure server 206 predicts which headless web browsers on which devices are needed. It makes the prediction based on past requests and how those requests specify web browsers with particular arguments and specify edge devices that execute the web browser based on criteria. Based on that analysis, infrastructure server 206 sends commands to various edge devices to pre-initialize the browsers. Then, when another request comes in, the infrastructure server will look at the requested browser arguments and edge device criteria, and select one of the pre-initialized browsers matching the arguments and running on an edge device matching the criteria. When browsers are no longer needed because the relevant arguments and criteria have not been recently requested, the infrastructure will send messages to respective edge devices asking that the browsers be closed. This is illustrated in FIGS. 5 and 6.

FIG. 5 illustrates a method 500 for warming up browsers based on a common list of arguments, according to an embodiment.

At step 502, the method detects new CDP sessions with a common list of arguments. As used herein, a “CDP session” refers to a session established using the Chrome DevTools Protocol (CDP), which allows for programmatic control of a browser instance. By detecting new CDP sessions that share a common set of arguments or configuration parameters, the method can identify opportunities to optimize performance by pre-warming browsers with frequently used configurations.

After detecting the common arguments, at step 504 the method calculates the number of browsers to warm up based on the number of sessions detected in step 502. The number of browsers to pre-initialize may be proportional to the frequency that a particular configuration is requested. For example, if 10 CDP sessions are detected all using the same arguments within a certain time period, the method may determine that another 10 browser instances should be pre-warmed with that configuration. The specific ratio of pre-warmed instances to the number of detected sessions may be preset or dynamically determined based on system resources and performance metrics.

If step 504 determines that additional browsers are needed to efficiently handle the detected CDP sessions, then at step 506 the method warms up the calculated number of browsers by initializing them with the common set of arguments identified in step 502. Pre-warming the browsers involves launching the browser instances and applying the configuration parameters so that the instances are ready to quickly serve incoming requests that match that configuration. This pre-initialization process improves performance by reducing the setup time when fulfilling requests.

However, similar to the determination in step 504, an infrastructure server may determine that too many browsers are already open, then at step 508 the method closes browsers using the arguments. Adjusting the pool of pre-initialized browser instances based on the real-time demand optimizes resource usage and maintains the benefits of the pre-warming process without over-utilizing system capacity.

The method ends at step 500 after completing the pre-warming or paring down of browser instances. By detecting frequently used sets of configuration arguments, predictively pre-initializing headless browsers with those arguments, and dynamically adjusting the number of pre-warmed instances, this method optimizes performance and resource utilization when serving CDP sessions and controlling remote browsers programmatically.

FIG. 6 depicts a method 600 for creating and managing browser sessions with different argument sets between a client 102 and an infrastructure server 206 and edge device 208, according to an embodiment. Although FIG. 6 depicts communications passing between infrastructure server 206 and edge device 208, in some embodiments, the communications may pass between infrastructure server 206 and application 211 at edge device 208.

At step 602, client 102 initiates the process by sending a request to infrastructure server 206 to create a new session with a browser argument set A1. The argument set A1 specifies the desired configuration parameters for the browser session.

Upon receiving the request, infrastructure server 206 opens a browser with argument set A1 at step 604. This initializes a new browser instance on edge device 208 using the configuration specified by the client in set A1.

At step 606, infrastructure server 206 sends a session OK message back to client 102, indicating that the requested browser session has been successfully created and is ready for interaction.

Client 102 then sends a request at step 608 to create another new session, this time specifying a different argument set A2. Infrastructure server 206 responds by opening a browser on edge device 208 using argument set A2, as shown at step 610.

This process of the client requesting browser sessions and the infrastructure server initializing them on the edge device continues for argument sets A3 through Ax, as depicted in steps 612 through 616. Each request from the client specifies a set of configuration arguments, and each newly created browser instance uses the respective argument set.

At step 618, infrastructure server 206 detects that there are S new sessions per T time frame that all use the same argument set A1. Based on the number of that S new sessions per T time frame, infrastructure server 206 determined argument set A1 is frequently requested and would benefit from having browser instances pre-warmed and ready to go. A similar determination may be made for the edge device based on prior filtering criteria requested for the edge device.

Accordingly, at step 620, infrastructure server 206 proactively creates a new session with argument set A1 by sending a request to edge device 208. This pre-warms a browser with configuration A1, as shown at step 622, without waiting for explicit client requests.

However, if one of the previously opened browsers with argument set A1 (bn) is no longer needed, client 102 may send a request at step 624 to reuse one of those already open Al browser instances rather than initializing a new one. A browser okay command is sent at 626. This allows for efficient recycling of resources.

At step 628, infrastructure server 206 detects that the ratio of new sessions using a particular argument set Ax (and possibility edge device filtering criteria) has changed. In response, infrastructure server 206 evaluates whether to close any unneeded browsers at step 630. If there are more A1 browsers initialized than needed based on the current ratio, some can be shut down to free up resources. Conversely, if a different argument set is now more in demand, additional instances may be pre-warmed using that configuration.

By monitoring the mix of session requests and proactively initializing or shutting down headless browsers in anticipation of demand, this method optimizes resource usage and improves performance in serving remote browsing sessions. The client and infrastructure server work together to predictively manage the pool of ready browser instances.

As described above, RPC may be used for interprocess communication, including the transmission of CDP commands. As used herein, RPC is different from HTTP3. As described above, conventionally RPC uses a transport layer protocol such as TCP. However, this can add additional transactions to the set up.

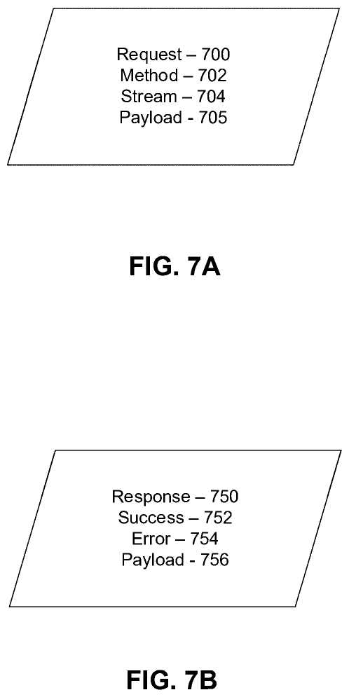

According to an embodiment, to reduce the required number of transactions, RPC may be transported over a QUIC protocol. QUIC protocol is typically used for web applications, not RPC. To support the communication, the RPC messages are assembled into frames. Each frame is a structure description that allows storing, sending, and receiving of discrete (as opposed to unknown) amounts of bytes (data). Request and response messages are exchanged. A request frame is a data structure that describes the RPC method being called and contains its argument data. A response frame is a data structure that describes the RPC response status and contains its response data. Both are packed using proto-buf or other methods such as MessagePack, Avro, Parquet, or just plain JSONs, or others. A skilled artisan would recognize this RPC-over-QUIC protocol can be applied to lots of different types of communication and is not limited to web scraping. The RPC over quick protocols described below with respect to FIGS. 7A-B, 8, and 9.

FIGS. 7A and 7B is a diagram illustrating packets to allow RPC to transact over a QUIC protocol, according to an embodiment.

FIG. 7A illustrates an example request frame 700 for requesting execution of a remote procedure call (RPC) using the QUIC protocol, according to embodiments of the present disclosure. Request frame 700 includes a method field 702, a stream field 704, and a payload field 705.

Method field 702 identifies the specific RPC method or function to be called on the remote device. This specifies which procedure should be executed by the server in response to receiving the request frame 700.

Stream field 704 indicates whether the QUIC stream used to send request frame 700 should be left open or closed after the RPC method completes execution on the server. One stream is for one RPC call, the stream cannot be reused for other RPC calls. Rather, other RPC calls will require new streams. This allows both peers to control QUIC stream lifetime.

Payload field 705 contains the input arguments and parameters needed for the server to execute the specified RPC method. This provides the server with the data it needs to perform the requested action.

The combination of method field 702, stream field 704, and payload field 705 in request frame 700 enables a client to efficiently initiate a remote procedure call to a server using the QUIC protocol. The various fields may be serialized as described above

By embedding the RPC details within a QUIC frame, the additional overhead and latency of using separate protocols for transport and RPC can be avoided. Request frame 700 is sent by the client over an established QUIC session and stream to the server to trigger execution of the specified RPC method with the provided arguments. This allows RPCs to take advantage of the performance and security benefits of QUIC while minimizing the total transaction count required. The server parses the received request frame 700 to extract the RPC details and execute the requested method.

FIG. 7B depicts an example response frame 750 for providing results of a remote procedure call (RPC) executed on a server back to a requesting client over QUIC, according to embodiments of the present disclosure. Response frame 750 includes a success field 752, an error field 754, and a payload field 756.

Success field 752 indicates whether the RPC method or function identified in the corresponding request frame was successfully executed by the server. This allows the client to easily determine if the remote procedure call was completed without error. In some embodiments, success field 752 is a Boolean value set to True if the RPC method ran successfully or False if an error occurred.

Error field 754 provides details on any errors encountered while attempting to execute the RPC method on the server. If success field 752 indicates the RPC failed, error field 754 can provide additional information to the client about the cause of the failure, such as an exception type or error message. This enables the client to take appropriate corrective action or display a meaningful error to the user. If no error occurred and success field 752 is set to True, error field 754 may be empty or omitted.

Payload field 756 contains the results and return values produced by executing the RPC method on the server. Upon receiving response frame 750, the client extracts the results from payload field 756 to obtain the outcome of the RPC invocation.

By including success field 752, error field 754 and payload field 756, response frame 750 provides a complete summary of the RPC execution status and results to the requesting client. The client can efficiently determine if the RPC succeeded and retrieve any returned values without requiring additional transactions or protocols. In cases where an error occurred, the client has immediate visibility into the cause of the failure.

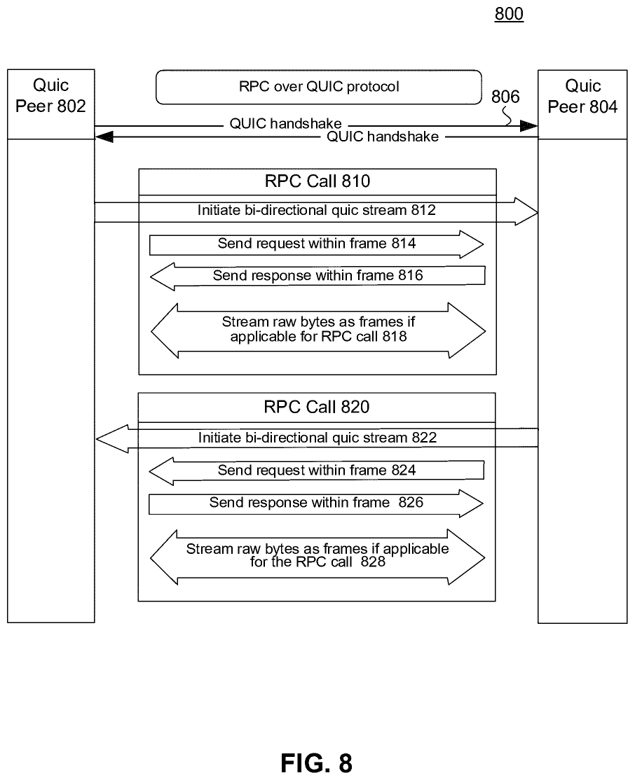

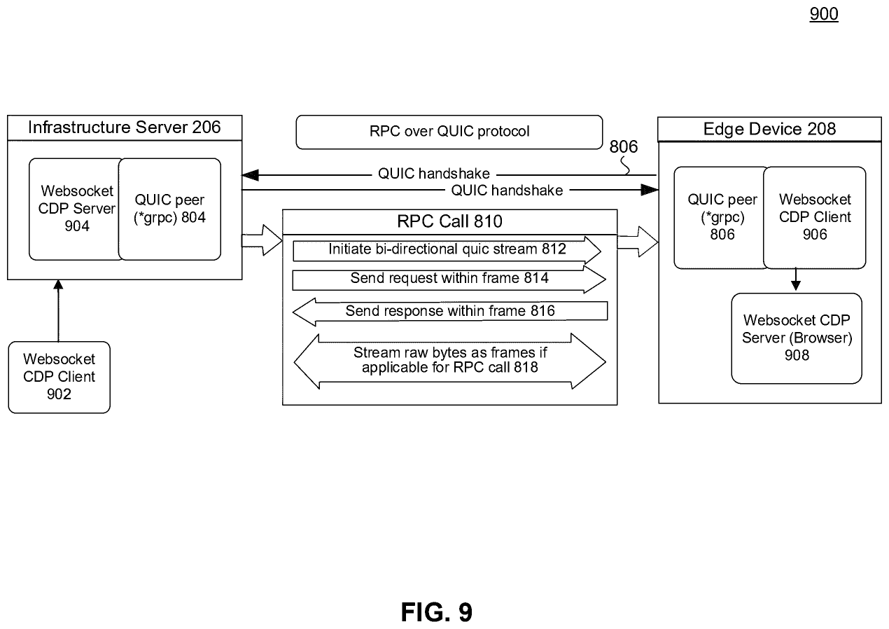

FIGS. 8 and 9 illustrate transacting packets over RPC according to an embodiment.

FIG. 8 illustrates an example system 800 for executing remote procedure calls (RPCs) between a client and server using the QUIC protocol, according to embodiments of the present disclosure. System 800 includes a QUIC peer 802 and a QUIC peer 804.

QUIC peer 802 and QUIC peer 804 represent the endpoints of the QUIC session. Either side can take on the client role and initiate RPCs to be executed by the other side acting as the server. QUIC peer 802 and QUIC peer 804 each maintain a complete implementation of the QUIC protocol stack, allowing them to establish sessions, exchange data, and gracefully handle errors.

To establish a QUIC session, QUIC peer 802 and QUIC peer 804 perform QUIC handshake 806. One is QUIC client the other is QUIC server for the handshake, after that they are both QUIC peers. This handshake process authenticates the endpoints, exchanges session configuration parameters, and establishes initial encryption keys. It may involve the initiating device first sending a TLS Hello message in the first packet. The counterparty server replies with a second packet including a TLS Hello, Fin, and Cert message. The initiating server replies to that with a Fin message in the third packet, and potentially can start sending secure data in the same packet. Successful completion of QUIC handshake 806 results in a secure, bi-directional communication channel between QUIC peer 802 and QUIC peer 804 that can be used to execute RPCs.

Once the session is established, either QUIC peer can initiate an RPC to be executed by its peer. The diagram depicts two such RPC invocations. First, RPC Call 810 is made by QUIC peer 802 to QUIC peer 804. To begin this call, QUIC peer 802 initiates bi-directional QUIC stream 812. The protocol to initiate QUIC stream 812 may be conventional to the QUIC protocol. QUIC streams provide independent, lightweight channels for data exchange within an overall QUIC session. By creating dedicated streams for each RPC, multiple RPCs can be executed concurrently without head-of-line blocking.

After the stream is established, QUIC peer 802 constructs a request frame 814 according to the format depicted in FIG. 7A. This request frame identifies the RPC method to invoke and contains the arguments for the method serialized in its payload. QUIC peer 802 then sends this request frame to QUIC peer 804 within the newly created QUIC stream.

Upon receipt of the request frame via the QUIC stream, QUIC peer 804 dispatches the RPC request to the appropriate handler based on the method identifier. The handler deserializes the arguments contained in the request frame payload and invokes the RPC method implementation. Once the RPC method completes, QUIC peer 804 constructs a response frame 750 as depicted in FIG. 7B. This response frame indicates the overall success or failure of the RPC, any error details, and the serialized return value of the method. At 816, QUIC peer 804 sends the response frame back to QUIC peer 802 via the same QUIC stream.

For RPCs that involve transferring raw byte streams, such as asynchronously downloading or uploading binary data, the QUIC stream can be used directly. In this case, after sending the response frame, QUIC peer 804 can stream the raw bytes to QUIC peer 802 as additional frames on the existing QUIC stream 818. These additional frames may include as payload the raw bytes. This avoids the overhead of creating separate streams for the RPC control messages and data transfer.

The diagram also depicts a second RPC call 820 in the reverse direction from QUIC peer 804 to QUIC peer 802. This RPC follows the same general pattern as RPC call 810. QUIC peer 804 initiates a new bi-directional QUIC stream 822, sends a request frame 824, and receives a response frame 826. If the RPC involves raw byte stream transfer, those bytes are sent as frames 828 within the existing stream.

By using bi-directional streams and frames to encapsulate RPC requests and responses, system 800 enables efficient, concurrent RPC execution over QUIC. The QUIC session provides a secure, low-latency foundation, while the frames provide a structured way to describe RPC methods, arguments, and results. Inline raw byte streaming support avoids unnecessary stream creation. The asynchronous, bi-directional nature of QUIC streams also allows RPC requests and responses to flow independently in both directions without blocking.

According to an advantage, a single handshake creates a QUIC session that can support multiple streams. Avoiding the need to do a handshake for each stream may be advantageous in that it may save the need to do additional network transactions for each stream. In addition, using QUIC for RPC is advantageous in that, once the QUIC stream is set up, asynchronous, bidirectional communication is enabled to transmit data between devices. Because transmission is asynchronous, requested information may be sent at a later time when it becomes available. Also, the multiple RPC calls 810 and 820 may operate in parallel.

FIG. 9 depicts an example system 900 for executing remote procedure calls (RPCs) between a browser and a server using the QUIC protocol, according to embodiments of the present disclosure. System 900 includes a WebSocket CDP client 902 (which may be executed on a client such as client 102), infrastructure server 206, and an edge device 208, and leverages RPC over QUIC protocol 806 to enable communication between the browser and server components.

Infrastructure server 206 contains a WebSocket CDP Server 904 and a QUIC peer 804. WebSocket CDP Server 904 exposes browser automation functionality using the Chrome DevTools Protocol (CDP) over a WebSocket connection. This allows external clients to control and interact with a browser instance running on the server. QUIC peer 804 implements the server side of the QUIC protocol stack and provides an endpoint for establishing QUIC session with clients. In system 900, QUIC peer 804 acts as an intermediary between WebSocket CDP Server 904 and the client, forwarding RPC requests and responses over QUIC.

Edge device 208 represents the client components of system 900. It includes a QUIC peer 802 which implements the client side of the QUIC protocol stack and provides an API for establishing QUIC session and executing RPCs. WebSocket CDP Client 906 is a client library that provides a high-level interface for interacting with a browser via the CDP protocol. In some embodiments, WebSocket CDP Client 906 may be implemented as an RPC client that exposes CDP functionality as RPC methods. Edge device layer 908 may also include additional WebSocket CDP clients 912 to enable concurrent interaction with multiple browser instances. In some embodiments, QUIC peer 802, WebSocket CDP Client 906, and WebSocket CDP server 908 may be part of application 211 at edge device 208.

To execute RPCs between the client and server components, system 900 establishes a QUIC session using RPC over QUIC protocol. This involves performing a QUIC handshake 806 as depicted in FIG. 8 to authenticate the parties and establish encryption keys. As shown in the example in FIG. 9, edge device 208 initiates the QUIC handshake. This may be advantageous in that this initiation may be used to signal to the infrastructure server 206 that edge device 208 is available to handle new requests. This may avoid the need for infrastructure server 206 to poll edge device 208. Once the QUIC session is established, the client components can initiate RPCs to the server.

As an example, consider a scenario where WebSocket CDP client 902 wishes to invoke a CDP method on the browser instance hosted by WebSocket CDP server 908. To begin this RPC, Websocket CDP client 902 initiates a procedure call, including relevant arguments and method name, to WebSocket CDP server 904. To Websocket CDP client 902, it may appear as if it is interacting with a local server. However, Websocket CDP server 904 constructs an RPC request frame 814 according to the format defined in FIG. 7A, specifying the CDP method to be invoked and its arguments. This request frame is sent by QUIC peer 804 to QUIC peer 802.

Upon receipt of the request frame, QUIC peer 802 extracts the CDP method and arguments and forwards them, via WebSocket CDP client 906, to WebSocket CDP server 908. WebSocket CDP server 908 invokes the corresponding method on the underlying browser instance and captures any results. It then sends the RPC results back, through Websocket CDP client 906 to QUIC peer 802.

QUIC peer 802 constructs an RPC response frame 816 containing the CDP method results as specified in FIG. 7B. This response frame is sent back to QUIC peer 804 over the same QUIC stream that carried the request. QUIC peer 804 can then return the RPC results to Websocket CDP Client 908 via its RPC API.

For CDP methods that involve transferring binary data, such as capturing screenshots or downloading content, the established QUIC stream can be used to transfer the raw bytes at 818. After sending the RPC response frame, WebSocket CDP server 908 can stream the binary data to WebSocket CDP client 906 and to QUIC peer 802, which in turn streams it to QUIC peer 804 as additional frames on the existing stream 818. QUIC peer 804 then make the binary data available to WebSocket CDP client 902 via WebSocket CDP server 904.

In an example operation of the headless browser process illustrated in FIG. 3, the initial request frame 814 may include a request to open a browser and may include arguments for the browser. It may be an RPC call to open a WebSocket connection to a browser. The response frame 816 may include an indication that the browser is available and successfully opened. Then, subsequent CDP commands can be sent as raw data on the stream 818 that has been left open. In this way, an entire web scrape transaction can take place over a single RPC call 810.

By leveraging QUIC and its stream-based communication model, system 900 enables efficient, secure execution of CDP methods between a client and remote browser instance. The QUIC session provides a low-latency, encrypted transport, while the request/response frames provide a structured way to describe CDP RPC methods and their results. QUIC's support for multiple concurrent streams allows many CDP RPCs to be executed in parallel. The system architecture also provides flexibility, allowing clients to interact with multiple remote browser instances hosted behind a common QUIC peer endpoint.

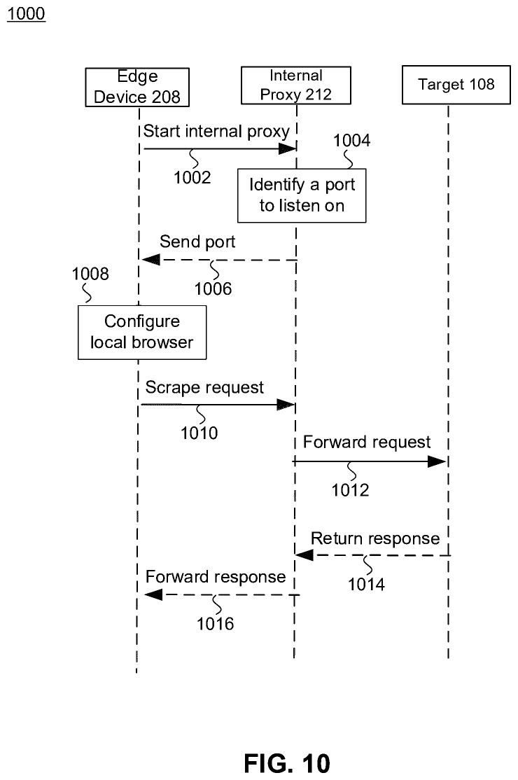

FIG. 10 is a flowchart showing a method for utilizing an internal proxy, according to an embodiment. At step 1002 edge device 208 launches an internal proxy. The internal proxy may be internal proxy 212. Internal proxy 212 may be located on the same device as edge device 208. Edge device 208 may launch internal proxy 212 responsive to receiving a web scrape request. In some embodiments, application 211 at edge device 208 may receive the web scrape request. As discussed above, application 211 at edge device 208 may launch internal proxy 212.

At step 1004, internal proxy 212 identifies a port to listen on. The port may be at edge device 208. In some embodiments, internal proxy 212 may reference a default port to listen on. The port may be a port not currently in use by another process. In some embodiments, internal proxy 212 may be unable to find an unused port. As a result, internal proxy 212 may return an error to edge device 208. At step 1006, internal proxy 212 sends the port it is listening on to edge device 208.

At step 1008, edge device 208 configures a local browser. In some embodiments, application 211 may configure the local browser. The local browser may be a headless browser, such as headless browser 210. The local browser may be configured to connect to internal proxy 212. For example, edge device 208 or application 211 may configure the local browser to connect to internal proxy 212 at the local host IP address (e.g., 127.0.0.1) and the port received at 1006 that internal proxy 212 is listening on. The local browser and internal proxy 212 may connect via HTTP. For example, internal proxy 212 may receive an HTTP connect from the local browser and establish the connection. In some embodiments, the local browser may be unable to connect to internal proxy 212. For example, internal proxy 212 may have encountered an error, or the IP address/port provided is incorrect. The local browser may report the connection failure to edge device

At step 1010, edge device 208 sends a scrape request to internal proxy 212. Application 211 may send the scrape request to internal proxy 212. The request may pass through the local browser to internal proxy 212. The scrape request may be a request for content at target 108. At step 1012, internal proxy 212 forwards to the request to target 108. In some embodiments, internal proxy 212 may establish an authenticated communication session (e.g., an encrypted communication session) with an external proxy server as part of handling the scrape request.

At step 1014, target 108 returns a response to internal proxy 212. The response including the content from target 108. At 1016, internal proxy 212 may forward the response to edge device 208. Internal proxy 212 may forward the response to headless browser 210 at edge device 208. Internal proxy 212 may generate metrics regarding messages passed between the local browser (e.g., headless browser 210) and target 108. For example, internal proxy 212 may calculate total number of messages passed, total amount (e.g., gigabytes) of data passed, identifiers of target 108 (e.g., IP address), or any combination thereof. Internal proxy 212 may report messages, metrics, or both to edge device 208, application 211, or another entity on network 204.

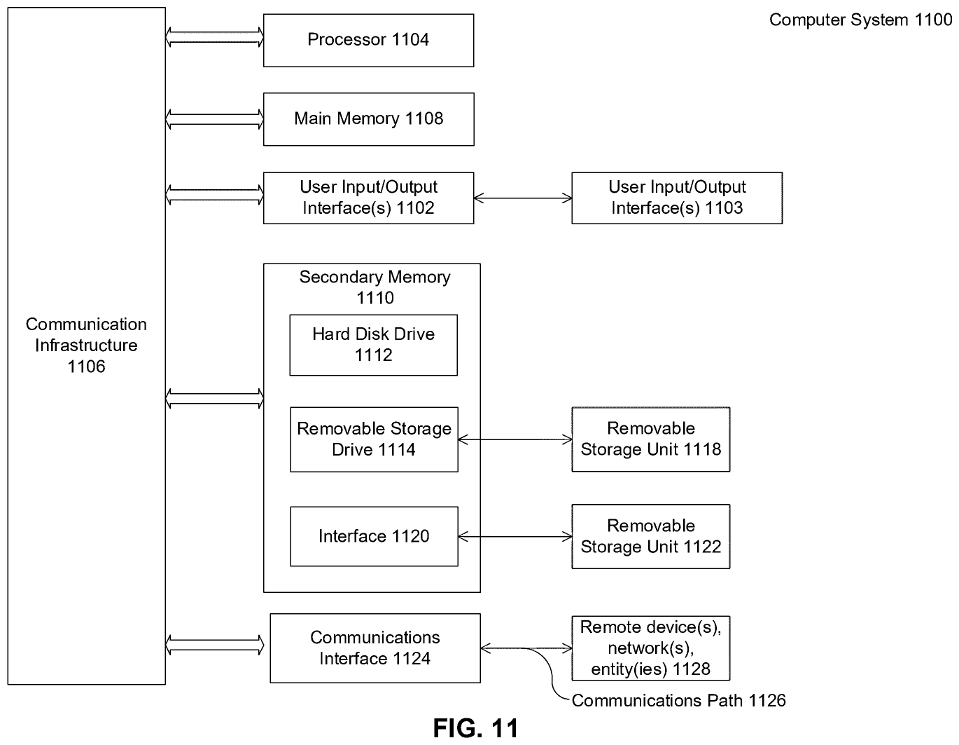

FIG. 11 is a system diagram illustrating an example computing device which may implement the various devices described above. Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (laaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

A computer-implemented method for executing a function on a remote device is presented, comprising:
(a) executing a Quick UDP Internet Connections (QUIC) handshake to create a QUIC session between a first peer device and a second peer device;
(b) opening a QUIC stream on the QUIC session between the first and second peer devices;
(c) generating, on the first peer device, a request frame comprising (i) a function name identifying a method on the second peer device to call using Remote Procedure Call (RPC) and (ii) a first payload including arguments for the function;
(d) sending, from the first peer device to the second peer device, the request frame over the QUIC stream; and
(e) receiving, on the first peer device from the second peer device, a response frame comprising an indication of that the method was successfully executed by the second peer device and a second payload with data from the Remote Procedure Call (RPC).

The method is presented, wherein the request frame includes a stream parameter indicating whether to leave the QUIC stream open after the method is complete, further comprising: when the stream parameter indicates to close the stream, closing the QUIC stream after the method on the second peer device is complete.

The method is presented, further comprising, when the stream parameter indicated to leave the QUIC stream open after the method is complete and after the response frame is received in (e):
(f) generating, on the first peer device, a second frame including a first payload;
(g) sending, from the first peer device to the second peer device, the second frame over the QUIC stream; and
(h) receiving, on the first peer device from the second peer device, a second frame, the second frame including a second payload.

The method is presented, wherein the QUIC stream is bidirectional in that the first peer device and the second peer device each includes a first thread to read the data and a second thread to write the data.

The method is presented, wherein the receiving (e) occurs asynchronously from the sending (d).

The method is presented, wherein the function name and first payload are serialized into the request frame using at least one of proto-buf, MessagePack, Avro, Parquet, JSONs and wherein the indication of that the method was successfully executed and the second payload are serialized into the response frame using the same encoding type as the request.

The method is presented, wherein the request frame and response frame are unmasked binary web socket frames or other frame types allowing sending discrete sized messages over a stream.

The method is presented, wherein the executing the QUIC handshake comprises: initiating the QUIC handshake by the second peer device.

The method is presented, wherein the method is a function to control a headless browser on the second peer device.

The method is presented, wherein the QUIC stream is a first QUIC stream, the request frame is a first request frame, and the response frame is a first response frame, further comprising:
opening a second QUIC stream on the QUIC session between the first peer device and the second peer device;
generating, on the first peer device, a second request frame comprising (i) a second function name identifying a second method on the second peer device to call using Remote Procedure Call (RPC) and (ii) a third payload including arguments for the function;
sending, from the second peer device to the first peer device, the second request frame over the QUIC stream; and
receiving, on the first peer device from the second peer device, a second response frame comprising an indication of that the second method was successfully executed by the second peer device and a fourth payload with data from the Remote Procedure Call (RPC).

A non-transitory, tangible computer-readable device is presented such that the device has instructions stored thereon that, when executed by at least one computing device, causes the at least one computing device to perform operations comprising:
(a) executing a Quick UDP Internet Connections (QUIC) handshake to create a QUIC session between a first peer device and a second peer device;
(b) opening a QUIC stream on the QUIC session between the first and second peer devices;
(c) generating, on the first peer device, a request frame comprising (i) a function name identifying a method on the second peer device to call using Remote Procedure Call (RPC) and (ii) a first payload including arguments for the function;
(d) sending, from the first peer device to the second peer device, the request frame over the QUIC stream; and
(e) receiving, on the first peer device from the second peer device, a response frame comprising an indication of that the method was successfully executed by the second peer device and a second payload with data from the Remote Procedure Call (RPC).

The device is presented, wherein the request frame includes a stream parameter indicating whether to leave the QUIC stream open after the method is complete, the operations further comprising: when the stream parameter indicates to close the stream, closing the QUIC stream after the method on the second peer device is complete.

The device is presented, the operations further comprising, when the stream parameter indicated to leave the QUIC stream open after the method is complete and after the response frame is received in (e):
(f) generating, on the first peer device, a second frame including a first payload;
(g) sending, from the first peer device to the second peer device, the second frame over the QUIC stream; and
(h) receiving, on the first peer device from the second peer device, a second frame, the second frame including a second payload.

The device is presented, wherein the QUIC stream is bidirectional in that the first peer device and the second peer device each includes a first thread to read the data and a second thread to write the data.

The device is presented, wherein the receiving (e) occurs asynchronously from the sending (d).

The device is presented, wherein the function name and first payload are serialized into the request frame using at least one of proto-buf, MessagePack, Avro, Parquet, JSONs and wherein the indication of that the method was successfully executed and the second payload are serialized into the response frame using the same encoding type as the request.

The device is presented, wherein the request frame and response frame are unmasked binary web socket frames or other frame types allowing sending discrete sized messages over a stream.

The device is presented, wherein the executing the QUIC handshake comprises: initiating the QUIC handshake by the second peer device.

The device is presented, wherein the method is a function to control a headless browser on the server.

The device is presented, wherein the QUIC stream is a first QUIC stream, the request frame is a first request frame, and the response frame is a first response frame, the operations further comprising:
opening a second QUIC stream on the QUIC session between the first peer device and the second peer device;
generating, on the first peer device, a second request frame comprising (i) a second function name identifying a second method on the second peer device to call using Remote Procedure Call (RPC) and (ii) a third payload including arguments for the function;
sending, from the second peer device to the first peer device, the second request frame over the QUIC stream; and
receiving, on the first peer device from the second peer device, a second response frame comprising an indication of that the second method was successfully executed by the second peer device and a fourth payload with data from the Remote Procedure Call (RPC).

A computer-implemented method for remotely controlling a headless browser is presented, the method comprising:
(a) receiving a message from a client to open a connection to a headless browser running on a device remote from the client;
(b) sending to the headless browser commands to provision the browser, the commands to configure the browser to appear as if the browser is controlled by a human;
(c) receiving, from the client, a command for controlling the headless browser;
(d) sending the command to the headless browser for execution;
(e) receiving, from the headless browser, a response to the command received in (c); and
(f) forwarding the response to the client.

The method is presented, further comprising:
(g) analyzing the command received in (c) to generate at least one additional command for controlling the headless browser; and
(h) sending the at least one additional command to the headless browser for execution.

The method is presented, further comprising:
(h) modifying the command, wherein the sending (d) comprises sending the command modified in (h).

The method is presented, wherein the headless browser commands to provision the browser comprise at least one of a command to adjust a browser profile.

The method is presented, wherein the at least one additional command comprises a command to report back an amount of data the browser transfers through a network with a target.

The method is presented, wherein the command is formatted according to at least one of a Chrome Devtools Protocol (CDP) protocol, a Webdriver protocol or Webdriver Bidi protocol.

A non-transitory, tangible computer-readable device is presented such that the device has instructions stored thereon that, when executed by at least one computing device, causes the at least one computing device to perform operations comprising:
(a) receiving a message from a client to open a connection to a headless browser running on a device remote from the client;
(b) sending to the headless browser commands to provision the browser, the commands to configure the browser to appear as if the browser is controlled by a human;
(c) receiving, from the client, a command for controlling the headless browser;
(d) sending the command to the headless browser for execution;
(e) receiving, from the headless browser, a response to the command received in (c); and
(f) forwarding the response to the client.

The device is presented, the operations further comprising:
(g) analyzing the command received in (c) to generate at least one additional command for controlling the headless browser; and
(h) sending the at least one additional command to the headless browser for execution.

The device is presented, further comprising:
(h) modifying the command, wherein the sending (d) comprises sending the command modified in (h).

The device is presented, wherein the headless browser commands to provision the browser comprise at least one of a command to adjust a browser profile.

The device is presented, wherein the at least one additional command comprises a command to report back an amount of data the browser transfers through a network with a target.

The device is presented, wherein the command is formatted according to at least one of a Chrome Devtools Protocol (CDP) protocol, a Webdriver protocol or Webdriver Bidi protocol.

A computer-implemented method for remotely controlling a headless browser is presented, comprising:
(a) initializing a plurality of headless browsers, each of the plurality of headless browsers being initialized with a configuration;
(b) after the plurality of headless browsers are initialized in (a), receiving, from a client, a request to control a headless browser, the request specifying a desired configuration for a headless browser session;
(c) based on the desired configuration, selecting one of the plurality of headless browsers;
(d) receiving, from the client, a command to control a headless browser; and
(e) forwarding the received command to the selected headless browser.

The method is presented, wherein each of the plurality of headless browsers is initialized with a different configuration.

The method is presented, wherein the selecting (c) comprises selecting one of the plurality of headless browsers such that the selected one matches the desired configuration.

The method is presented, wherein each of the plurality of headless browsers is initialized on a different edge device

The method is presented, wherein the request specifies criteria for an edge device, and wherein the selecting (c) comprises selecting one of the plurality of headless browsers such that the selected one is running on an edge device that matches the criteria.

The method is presented, wherein each of the plurality of headless browsers is initialized with the same configuration.

The method is presented, further comprising:
(f) prior to the initializing (a), receiving a plurality of requests each including arguments specifying a respective configuration of a desired configuration for a headless browser session;
(g) determining a quantity of the plurality of requests with arguments specifying the same configuration;
(h) based on the quantity determined in (g), determining a number of headless browsers to initialize in (a).

The method is presented, wherein the plurality of requests each specify criteria for a desired edge device;
wherein determining (g) include determining the quantity of the plurality of requests with arguments specifying the same configuration and with a particular criteria for the desired edge device, and
wherein the initializing comprises initializing the plurality of headless browsers having the same configuration and on an edge device with the particular criteria.

The method is presented, wherein the plurality of requests each specify criteria for a desired edge device,
wherein determining (g) include determining the quantity of the plurality of requests with arguments specifying the same configuration and with a particular criteria for the desired edge device, and
wherein the initializing comprises initializing the plurality of headless browsers having the same configuration and on the desired edge device with the particular criteria. The method is presented, wherein the plurality of requests is a first plurality of requests, further comprising:
(f) after the initializing (a), receiving a second plurality of requests each including arguments specifying a respective configuration of a desired configuration for a headless browser session;
(g) determining a second quantity of the second plurality of requests with arguments specifying the same configuration;
(h) based on the second quantity determined in (g), determining a number of headless browsers to close; and
(i) closing the determined number in (h) of the plurality of browsers.

A non-transitory, tangible computer-readable device is presented such that the device has instructions stored thereon that, when executed by at least one computing device, causes the at least one computing device to perform operations comprising:
(a) initializing a plurality of headless browsers, each of the plurality of headless browsers being initialized with a configuration;
(b) after the plurality of headless browsers are initialized in (a), receiving, from a client, a request to control a headless browser, the request specifying a desired configuration for a headless browser session;
(c) based on the desired configuration, selecting one of the plurality of headless browsers;
(d) receiving, from the client, a command to control a headless browser; and
(e) forwarding the received command to the selected headless browser.

The device is presented, wherein each of the plurality of headless browsers is initialized with a different configuration.

The device is presented, wherein the selecting (c) comprises selecting one of the plurality of headless browsers such that the selected one matches the desired configuration.

The device is presented, wherein each of the plurality of headless browsers is initialized on a different edge device

The device is presented, wherein the request specifies criteria for an edge device, and wherein the selecting (c) comprises selecting one of the plurality of headless browsers such that the selected one is running on an edge device that matches the criteria.

The device is presented, wherein each of the plurality of headless browsers is initialized with the same configuration.

The device is presented, the operations further comprising:
(f) prior to the initializing (a), receiving a plurality of requests each including arguments specifying a respective configuration of a desired configuration for a headless browser session;
(g) determining a quantity of the plurality of requests with arguments specifying the same configuration;
(h) based on the quantity determined in (g), determining a number of headless browsers to initialize in (a).

The device is presented, wherein the plurality of requests each specify criteria for a desired edge device,
wherein determining (g) include determining the quantity of the plurality of requests with arguments specifying the same configuration and with a particular criteria for the desired edge device, and
wherein the initializing comprises initializing the plurality of headless browsers having the same configuration and on the desired edge device with the particular criteria.

The device is presented, wherein the plurality of requests each specify criteria for a desired edge device,
wherein determining (g) include determining the quantity of the plurality of requests with arguments specifying the same configuration and with a particular criteria for the desired edge device, and
wherein the initializing comprises initializing the plurality of headless browsers having the same configuration and on the desired edge device with the particular criteria.

The device is presented, wherein the plurality of requests is a first plurality of requests, the operations further comprising:
(f) after the initializing (a), receiving a second plurality of requests each including arguments specifying a respective configuration of a desired configuration for a headless browser session;
(g) determining a second quantity of the second plurality of requests with arguments specifying the same configuration;
(h) based on the second quantity determined in (g), determining a number of headless browsers to close; and
(i) closing the determined number in (h) of the plurality of browsers.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method for executing a function on a remote device, comprising:
(a) executing a Quick UDP Internet Connections (QUIC) handshake to create a QUIC session between a first peer device and a second peer device;
(b) opening a QUIC stream on the QUIC session between the first and second peer devices;
(c) generating, on the first peer device, a request frame comprising (i) a function field identifying a method on the second peer device to call using Remote Procedure Call (RPC) and (ii) a first payload field for a first payload, wherein the first payload includes arguments for executing the function;
(d) sending, from the first peer device to the second peer device, the request frame over the QUIC stream; and
(e) receiving, on the first peer device from the second peer device, a response frame comprising:
(i) a success field, wherein the success field is an indication of that the method was successfully executed by the second peer device,
(ii) an error field, wherein the error field provides details of errors encountered by the second peer device while executing the method, and
(iii) a second payload field for a second payload, wherein the second payload comprises output data from the Remote Procedure Call (RPC).

2. The method of claim 1, wherein the request frame includes a stream field indicating whether to leave the QUIC stream open after the method is complete, further comprising:
when the stream field indicates to close the stream, closing the QUIC stream after the method on the second peer device is complete.

3. The method of claim 2, further comprising, wherein the QUIC stream is a first QUIC stream, the request frame is a first request frame, and the response frame is a first response frame and wherein the stream field indicated to leave the QUIC stream open after the method is complete and after the response frame is received in (e):
(f) generating, on the first peer device, a second request frame including a third payload;
(g) sending, from the first peer device to the second peer device, the second request frame over the QUIC stream; and
(h) receiving, on the first peer device from the second peer device, a second response frame, the second response frame including a fourth payload.

4. The method of claim 1, wherein the QUIC stream is bidirectional in that the first peer device and the second peer device each includes a first thread to read the data and a second thread to write the data.

5. The method of claim 1, wherein the receiving (e) occurs asynchronously from the sending (d).

6. The method of claim 1, wherein the function field and first payload field are serialized into the request frame using at least one of proto-buf, MessagePack, Avro, Parquet, JSONs and wherein the success field and the second payload field are serialized into the response frame using the same encoding type as the request.

7. The method of claim 1, wherein the request frame and response frame are unmasked binary web socket frames or other frame types allowing sending discrete sized messages over a stream.

8. The method of claim 1, wherein the executing the QUIC handshake comprises:
initiating the QUIC handshake by the second peer device.

9. The method of claim 1, wherein the method is a function to control a headless browser on the second peer device.

10. The method of claim 1, wherein the QUIC stream is a first QUIC stream, the request frame is a first request frame, and the response frame is a first response frame, further comprising:
opening a second QUIC stream on the QUIC session between the first peer device and the second peer device;
generating, on the first peer device, a second request frame comprising (i) a second function field identifying a second method on the second peer device to call using Remote Procedure Call (RPC) and (ii) a third payload field for a third payload, wherein the third payload includes arguments for executing the second function;
sending, from the second peer device to the first peer device, the second request frame over the QUIC stream; and
receiving, on the first peer device from the second peer device, a second response frame comprising:
(i) a second success field, wherein the second success field is an indication of that the second method was successfully executed by the second peer device,
(ii) a second error field, wherein the second error field provides details of errors encountered by the second peer device while executing the second method, and
(iii) a fourth payload field for a fourth payload, wherein the fourth payload comprises output data from the Remote Procedure Call (RPC).

11. A non-transitory, tangible computer-readable device having instructions stored thereon that, when executed by at least one computing device, causes the at least one computing device to perform operations comprising:
(a) executing a Quick UDP Internet Connections (QUIC) handshake to create a QUIC session between a first peer device and a second peer device;
(b) opening a QUIC stream on the QUIC session between the first and second peer devices;
(c) generating, on the first peer device, a request frame comprising (i) a function field identifying a method on the second peer device to call using Remote Procedure Call (RPC) and (ii) a first payload field for a first payload, wherein the first payload includes arguments for executing the function;
(d) sending, from the first peer device to the second peer device, the request frame over the QUIC stream; and
(e) receiving, on the first peer device from the second peer device, a response frame comprising:
(i) a success field, wherein the success field is an indication of that the method was successfully executed by the second peer device,
(ii) an error field, wherein the error field provides details of errors encountered by the second peer device while executing the method, and
(iii) a second payload field for a second payload, wherein the second payload comprises output data from the Remote Procedure Call (RPC).

12. The device of claim 11, wherein the request frame includes a stream field indicating whether to leave the QUIC stream open after the method is complete, the operations further comprising:
when the stream field indicates to close the stream, closing the QUIC stream after the method on the second peer device is complete.

13. The device of claim 12, the operations further comprising, wherein the QUIC stream is a first QUIC stream, the request frame is a first request frame, and the response frame is a first response frame and wherein the stream field indicated to leave the QUIC stream open after the method is complete and after the response frame is received in (e):
(f) generating, on the first peer device, a second request frame including a third payload;
(g) sending, from the first peer device to the second peer device, the second request frame over the QUIC stream; and
(h) receiving, on the first peer device from the second peer device, a second response frame, the second response frame including a fourth payload.

14. The device of claim 11, wherein the QUIC stream is bidirectional in that the first peer device and the second peer device each includes a first thread to read the data and a second thread to write the data.

15. The device of claim 11, wherein the receiving (e) occurs asynchronously from the sending (d).

16. The device of claim 11, wherein the function field and first payload field are serialized into the request frame using at least one of proto-buf, MessagePack, Avro, Parquet, JSONs and wherein the success field and the second payload field are serialized into the response frame using the same encoding type as the request.

17. The device of claim 11, wherein the request frame and response frame are unmasked binary web socket frames or other frame types allowing sending discrete sized messages over a stream.

18. The device of claim 11, wherein the executing the QUIC handshake comprises:
initiating the QUIC handshake by the second peer device.

19. The device of claim 11, wherein the method is a function to control a headless browser on the server.

20. The device of claim 11, wherein the QUIC stream is a first QUIC stream, the request frame is a first request frame, and the response frame is a first response frame, the operations further comprising:
opening a second QUIC stream on the QUIC session between the first peer device and the second peer device;
generating, on the first peer device, a second request frame comprising (i) a second function field identifying a second method on the second peer device to call using Remote Procedure Call (RPC) and (ii) a third payload field for a third payload, wherein the third payload includes arguments for executing the second function;
sending, from the second peer device to the first peer device, the second request frame over the QUIC stream; and
receiving, on the first peer device from the second peer device, a second response frame comprising:
(i) a second success field, wherein the second success field is an indication of that the second method was successfully executed by the second peer device,
(ii) a second error field, wherein the second error field provides details of errors encountered by the second peer device while executing the second method, and
(iii) a fourth payload field for a fourth payload, wherein the fourth payload comprises output data from the Remote Procedure Call (RPC).

21. A system for executing a function on a remote device, the system comprising:
a memory; and
at least one processor coupled to the memory and configured to:
(a) execute a Quick UDP Internet Connections (QUIC) handshake to create a QUIC session between a first peer device and a second peer device;
(b) open a QUIC stream on the QUIC session between the first and second peer devices;
(c) generating, on the first peer device, a request frame comprising (i) a function field identifying a method on the second peer device to call using Remote Procedure Call (RPC) and (ii) a first payload field for a first payload, wherein the first payload includes arguments for executing the function;
(d) send, from the first peer device to the second peer device, the request frame over the QUIC stream; and
(e) receiving, on the first peer device from the second peer device, a response frame comprising:
(i) a success field, wherein the success field is an indication of that the method was successfully executed by the second peer device,
(ii) an error field, wherein the error field provides details of errors encountered by the second peer device while executing the method, and
(iii) a second payload field for a second payload, wherein the second payload comprises output data from the Remote Procedure Call (RPC).

22. The system of claim 21, wherein the request frame includes a stream field indicating whether to leave the QUIC stream open after the method is complete, the at least one processor further configured to:
when the stream field indicates to close the stream, close the QUIC stream after the method on the second peer device is complete.

23. The system of claim 22, further comprising, wherein the QUIC stream is a first QUIC stream, the request frame is a first request frame, and the response frame is a first response frame and wherein the stream field indicated to leave the QUIC stream open after the method is complete and after the response frame is received in (e), the at least one processor further configured to:
(f) generate, on the first peer device, a second request frame including a third payload;
(g) send, from the first peer device to the second peer device, the second request frame over the QUIC stream; and
(h) receive, on the first peer device from the second peer device, a second response frame, the second response frame including a fourth payload.

24. The system of claim 21, wherein the QUIC stream is bidirectional in that the first peer device and the second peer device each includes a first thread to read the data and a second thread to write the data.

25. The system of claim 21, wherein the receiving (e) occurs asynchronously from the sending (d).

26. The system of claim 21, wherein the function field and first payload field are serialized into the request frame using at least one of proto-buf, MessagePack, Avro, Parquet, JSONs and wherein the success field and the second payload field are serialized into the response frame using the same encoding type as the request.

27. The system of claim 21, wherein the request frame and response frame are unmasked binary web socket frames or other frame types allowing sending discrete sized messages over a stream.

28. The system of claim 21, wherein the executing the QUIC handshake comprises:
initiating the QUIC handshake by the second peer device.

29. The system of claim 21, wherein the method is a function to control a headless browser on the second peer device.

30. The system of claim 21, wherein the QUIC stream is a first QUIC stream, the request frame is a first request frame, and the response frame is a first response frame, the at least one processor further configured to:
open a second QUIC stream on the QUIC session between the first peer device and the second peer device;
generate, on the first peer device, a second request frame comprising (i) a second function field identifying a second method on the second peer device to call using Remote Procedure Call (RPC) and (ii) a third payload field for a third payload, wherein the third payload includes arguments for executing the second function;
send, from the second peer device to the first peer device, the second request frame over the QUIC stream; and
receive, on the first peer device from the second peer device, a second response frame comprising:
(i) a second success field, wherein the second success field is an indication of that the second method was successfully executed by the second peer device,
(ii) a second error field, wherein the second error field provides details of errors encountered by the second peer device while executing the second method, and
(iii) a fourth payload field for a fourth payload, wherein the fourth payload comprises output data from the Remote Procedure Call (RPC).
